(19) United States
(12) Patent Application Publication
(10) Pub. No.: US 2013/0218963 A1
(43) Pub. Date: Aug. 22, 2013

(54) NON-TRANSITORY COMPUTER READABLE RECORDING MEDIUM RECORDING INFORMATION PROCESSING PROGRAM, INFORMATION PROCESSING APPARATUS, INFORMATION PROCESSING SYSTEM, AND INFORMATION PROCESSING METHOD

(71) Applicant: Koichi HAYASHIDA, Kyoto (JP)

(72) Inventor: Koichi HAYASHIDA, Kyoto (JP)

(73) Assignee: NINTENDO CO., LTD., Kyoto (JP)

(21) Appl. No.: 13/553,390

(22) Filed: Jul. 19, 2012

(30) Foreign Application Priority Data
Feb. 16, 2012 (JP) 2012-031857

(51) Int. Cl. G06F 15/16

(52) U.S. Cl. 709/204

(57) ABSTRACT

An example information processing apparatus includes a storage unit that stores invisible information set so as to be invisible to a user of the information processing apparatus, and a transmitting unit that transmits the invisible information to another information processing apparatus by including the invisible information in notification information which is to be notified to a user of the other information processing apparatus. In addition, the information processing apparatus includes a receiving unit that receives, from the other information processing apparatus, invisible information set so as to be invisible to the user of the other information processing apparatus, and a display processing unit that causes the invisible information received by the receiving unit to be displayed on a display device.

### CROSS-REFERENCE TO RELATED APPLICATIONS

This application is based upon and claims the benefit of priority of the prior Japanese Patent Application No. JP2012-031857, filed on Feb. 16, 2012, the entire contents of which are incorporated herein by reference.

### FIELD

The present disclosure relates to a non-transitory computer readable recording medium that records an on processing program, an information processing apparatus, an information processing system, and an information processing method, for performing data exchange.

### BACKGROUND AND SUMMARY

Conventionally, there is a technique that enables a game apparatus to detect another game apparatus that exists within a predetermined range as a communication partner and to transmit and receive exchangeable data to/from the game apparatus of the communication partner.

One mode of the present disclosure is a non-transitory computer readable recording medium recording an information processing program that is executed by an information processing apparatus capable of communication. The information processing program causes the information processing apparatus to function as: a storage unit that stores invisible information set so as to be invisible to a user of the information processing apparatus; and a transmitting unit that transmits notification information which includes the invisible information and which is to be notified to a user of another information processing apparatus, to the other information processing apparatus.

Invisible information that is set so as to be invisible to a user in the information processing apparatus is included in notification information and transmitted to the other information processing apparatus. Therefore, the user of the other information processing apparatus is able to access invisible information that is set so as to be invisible to the user in the information processing apparatus that is a source of the notification information. By telling the invisible information included in the notification information to the user of the information processing apparatus that is the source of the notification information, the user of the other information processing apparatus can open a line of communication between users. As a result, communication between users is promoted.

In addition, the information processing program recorded on the recording medium that is one mode of the present disclosure causes the information processing apparatus to function as: a receiving unit that receives notification information including invisible information set so as to be invisible to the user of the other information processing apparatus; and a display processing unit that causes the invisible information included in the notification information received by the receiving unit to be displayed on a display device. Accordingly, users of information processing apparatuses can exchange invisible information of each other, and by exchanging invisible information with each other, communication between the users can be promoted.

Furthermore, with the information processing program recorded on the recording medium that is one mode of the present disclosure, the transmitting unit may transmit visible information that is set so as to be visible to the user of the information processing apparatus by including the visible information in the notification information together with the invisible information that is set so as to be invisible to the user of the information processing apparatus. For example, visible information is information that is enable to extrapolate the user of the information processing apparatus. In addition, an example of information that is enable to extrapolate the user of the information processing apparatus is character data regarding the user of the information processing apparatus. As a result of visible information of the information processing apparatus included in the notification information, information can be shared with a user of another information processing apparatus and topics of conversation are increased. Furthermore, due to the transmission of information that is enable to extrapolate the user of the information processing apparatus to another information processing apparatus, the user of the information processing apparatus can be readily discerned.

In addition, with the information processing program recorded on the recording medium that is one mode of the present disclosure, the transmitting unit may transmit, to the other information processing apparatus that is capable of executing a common application program with the information processing apparatus, invisible information which is related to the common application program and is set so as to be invisible to the user of the information processing apparatus, by including the invisible information in the notification information. Accordingly, information regarding the common application program is transmitted to the other information processing apparatus, and communication can be promoted regarding a topic that is shared between the user of the information processing apparatus and the user of the other information processing apparatus.

Furthermore, with the information processing program recorded on the recording medium that is one mode of the present disclosure, the common application program is a game program, and the transmitting unit may transmit invisible information which does not impede progress of the game program and is set so as to be invisible to the user of the information processing apparatus, by including the invisible information in the notification information. Accordingly, communication between users can be promoted without the execution of the information processing program that is one mode of the present disclosure impeding the progress of the game program to the information processing apparatus and to the other information processing apparatus.

In addition, with the information processing program recorded on the recording medium that is one mode of the present disclosure, the information processing apparatus has a wireless communication function, and the transmitting unit may transmit the invisible information which is set so as to be invisible to the user of the information processing apparatus, to another information processing apparatus existing within a propagation range of radio waves transmitted by the information processing apparatus, by including the invisible information in the notification information. Furthermore, the transmitting unit may transmit the notification information to all other information processing apparatuses existing in the propagation range of radio waves transmitted by the information processing apparatus. A change in other information processing apparatuses existing within the propagation range of radio waves transmitted by the information processing apparatus signifies a change in communication partners. As a result, communication can be established with a greater number of users.

Moreover, the present disclosure may be a method, a system, an information processing apparatus, or a program recorded on a recording medium that is readable by a device such as a computer, a machine, and the like. In this case, a non-transitory computer readable recording medium readable by a computer refers to a recording medium which accumulates information such as data and programs by electrical, magnetic, optical, mechanical, or chemical action, and which can be read from a computer or the like.

### BRIEF DESCRIPTION OF THE DRAWINGS

FIG. 1 shows an example non-limiting configuration of an information processing system;

FIG. 2 shows an example non-limiting hardware configuration of a game apparatus;

FIG. 3 shows an example non-limiting functional block of a game apparatus;

FIG. 4 shows an example non-limiting usage of a storage area of an auxiliary storage device of a game apparatus and a storage area of an auxiliary storage device of a wireless communication module;

FIG. 5 shows an example non-limiting flow chart of a transmitting/receiving process of exchangeable data; and

FIG. 6 shows an example non-limiting display screen of exchangeable data (received data) received from a game apparatus of a communication partner.

### DETAILED DESCRIPTION OF NON-LIMITING EXAMPLE EMBODIMENTS

Hereinafter, an embodiment of the present disclosure will be described with reference to the drawings. The following configuration is an exemplification and the present disclosure is not limited to the configuration of the embodiment.

An object of the present disclosure is to provide a recording medium recording an information processing program, an information processing apparatus, an information processing system, and an information processing method, for promoting communication between users of information processing apparatuses.

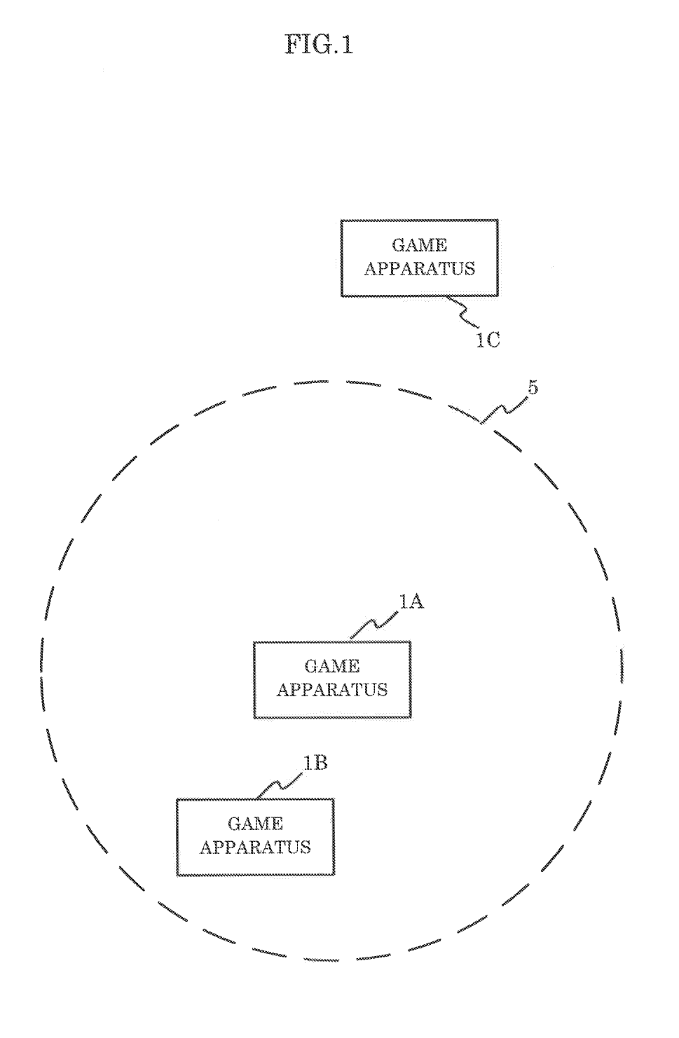

FIG. 1 is a diagram illustrating a configuration example of an information processing system according to the present embodiment. The information processing system according to the present embodiment includes a plurality of information processing apparatuses. As examples of information processing apparatuses, FIG. 1 illustrates portable game apparatuses 1A, 1B, and 1C. The game apparatuses 1A, 1B, and 1C are respectively capable of wire communication and are devices that can exchange data through wireless communication. However, the information processing apparatuses included in the information processing system are not limited to portable game apparatuses. Information processing apparatuses included in the information processing system may be a mobile phone terminal, a smart phone, a tablet mobile terminal, a notebook-sized personal computer, and the like. Hereinafter, when indicating a portable game apparatus including the game apparatuses 1A, 1B, and 1C, the portable game apparatus will simply be referred to as a game apparatus 1.

In addition, in FIG. 1, a communication range 5 when the game apparatus 1A executes wireless communication is depicted by a dotted line. The communication range is, for example, a range reached by radio waves transmitted by the game apparatus 1A. The game apparatus 1B exists within the communication range 5 of the game apparatus 1A. The game apparatus 1C exists outside the communication range 5 of the game apparatus 1A. In addition, it is assumed that a same game application program as that registered in the game apparatus 1A is registered in the game apparatus 1B.

In the example illustrated in FIG. 1, the game apparatus 1A detects the game apparatus 1B that satisfies predetermined conditions as a communication partner and exchanges data with the game apparatus 1B. For example, the predetermined conditions are: existing within the communication range of the game apparatus 1A; having a game application program registered that is the same as a game application program registered to or executable by the game apparatus 1A, and the like. The data that is exchanged includes data which is related to the game application program and which is not notified to a user of the game apparatus 1A (own game apparatus) but is notified to a user of a game apparatus of the communication partner (another game apparatus). Data that is not notified to the user of the game apparatus 1A (own game apparatus) but is notified to the user of the game apparatus of the communication partner 1B (other game apparatus) is, for example, information that does not impede the progress of a game such as the number of retries (the number of failures) in a game. Accordingly, since the communication partner acquires information not recognized by oneself, by having the communication partner share this information or the like, a new line of conversation can be opened and communication with the communication partner can be promoted.

<Configuration of Game Apparatus>

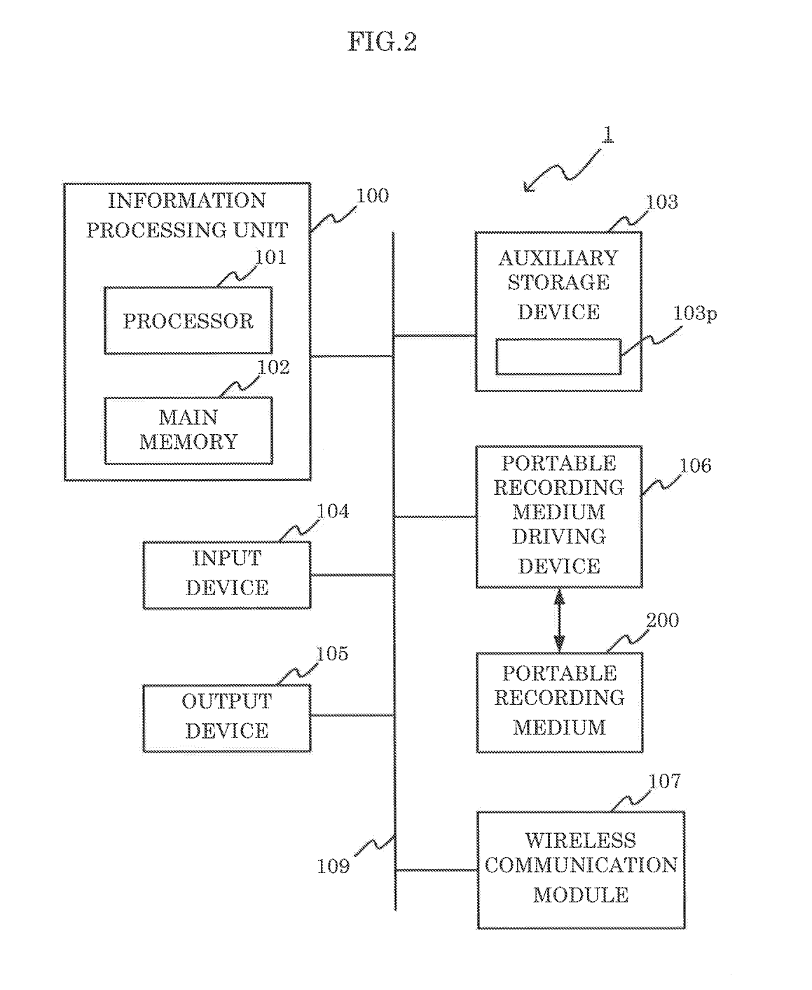

FIG. 2 illustrates an example of a hardware configuration of the game apparatus 1. The game apparatus 1 includes an information processing unit 100, an auxiliary storage device 103, an input device 104, an output device 105, a portable recording medium driving device 106, and a wireless communication module 107, which are all connected to each other by a bus 109.

For example, the input device 104 is a touch panel, operating buttons, or the like. In addition, the input device 104 may include an audio input device such as a microphone and an image input device such as a camera. Data inputted from the input device 104 is outputted to the information processing unit 100.

The auxiliary storage device 103 stores a plurality of programs and data used by the information processing unit 100 upon execution of the respective programs. For example, programs stored in the auxiliary storage device 103 include an operating system (OS), a data exchange program 103p, a game program, and other various application programs. For example, the auxiliary storage device 103 is a NAND type flash memory. The auxiliary storage device 103 provided in the game apparatus 1 is not limited to one and, for example, the game apparatus 1 may be equipped with a plurality of auxiliary storage devices 103 depending on the intended use.

The portable recording medium driving device 106 drives a portable recording medium 200 and performs input/output of data to/from the portable recording medium 200 in response to a signal from the information processing unit 100. The portable recording medium 200 is, for example, a recording medium such as a memory card, and stores an application program such as a game program.

The information processing unit 100 includes a processor 101 and a main memory 102. The main memory 102 provides the processor 101 with a storage area and a work area for loading a program stored in the auxiliary storage device 103 and/or the portable recording medium 200, and is also used as a buffer. For example, the main memory 102 is a semiconductor memory such as a PSRAM (Pseudo-Static Random Access Memory).

For example, the processor 101 is a CPU (Central Processing Unit) or a DSP (Digital Signal Processor). The processor 101 executes various processes by loading, to the main memory 102, and executing an OS, the data exchange program 103p, a game program, or an application program stored in the auxiliary storage device 103, or an application program and the like stored in the portable recording medium 200.

The output device 105 outputs a processing result of the information processing unit 100. The output device 105 includes a display or the like. In addition, the output device 105 may include an audio output device such as a speaker.

The wireless communication module 107 executes a process related to wireless communication through which the game apparatus 1 transmits/receives data to/from an external device. The wireless communication module 107 comprises a processor, a main memory, an auxiliary storage device, a data modulation/demodulation circuit, an antenna (all not shown), and the like. For example, the main memory of the wireless communication module 107 is a RAM. For example, the auxiliary storage device of the wireless communication module is a flash ROM. Moreover, a radio field strength used by the wireless communication module 107 is set in compliance to the Radio Act to a small value that can be used by a user without a license.

For example, the wireless communication module 107 modulates inputted data according to an instruction from the information processing unit 100 of a main body of the game apparatus 1 with the data modulation/demodulation circuit, and transmits radio waves from the antenna. In addition, for example, the wireless communication module 107 receives radio waves transmitted from another game apparatus with the antenna, and demodulates the received data with the data modulation/demodulation circuit. The demodulated received data is temporarily stored in the main memory of the wireless communication module 107, and is subsequently outputted to the information processing unit 100 of the main body of the game apparatus 1.

A process for searching for a communication partner to exchange data is executed when, for example, a predetermined program is executed by the processor of the wireless communication module 107. When a communication partner is found, the wireless communication module 107 notifies information on the communication partner to the information processing unit 100 of the main body of the game apparatus 1. Subsequently, according to an instruction from the information processing unit 100, the wireless communication module 107 executes a process for establishing a connection with the communication partner, and after the connection is established, executes a data transmission/reception process. Specifically, the data transmission/reception process of the wireless communication module 107 involves, for example, relaying data transmission/reception between the information processing unit 100 of the main body of the game apparatus 1 and an apparatus of the communication partner. In addition, the wireless communication module 107 is also capable of transmitting data to another device according to an instruction from the processor of the wireless communication module 107. Furthermore, the wireless communication module 107 executes a process for terminating the connection with the communication partner according to an instruction from the information processing unit 100.

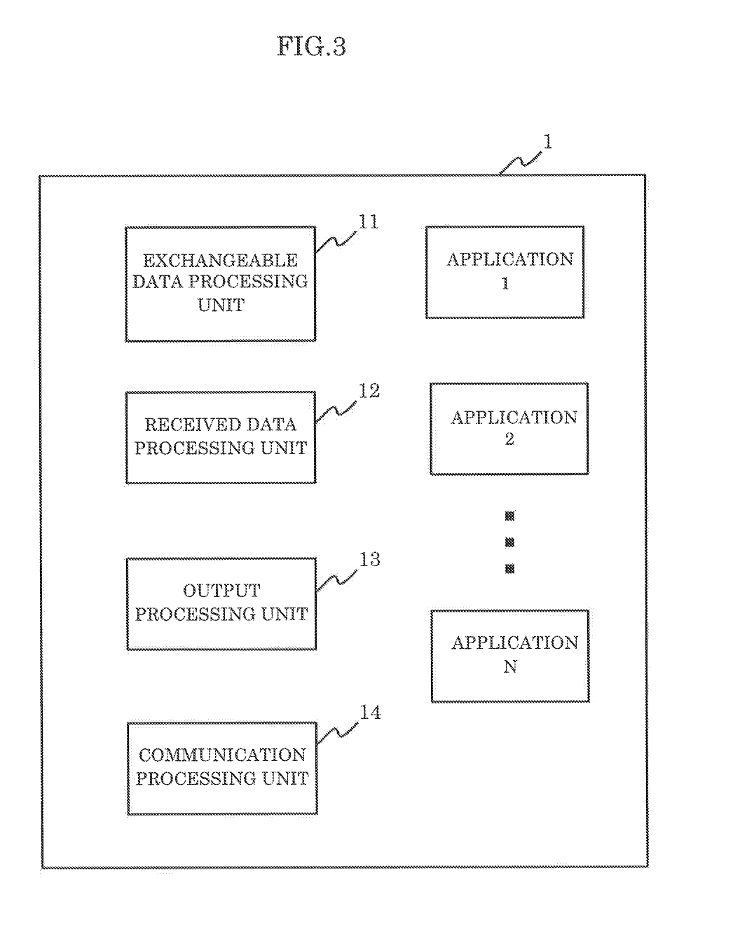

FIG. 3 is a diagram illustrating an example of a functional block of the game apparatus 1. Through execution of the data exchange program 103p by the information processing unit 100, the game apparatus 1 operates as an exchangeable data processing unit 11, a received data processing unit 12, and an output processing unit 13. In addition, through execution of a predetermined program by the processor of the wireless communication module 107, the game apparatus 1 operates as a communication processing unit 14. FIG. 3 also illustrates a functional block of application programs running on the game apparatus 1 (in FIG. 3, denoted as applications 1, 2, . . . , N).

The exchangeable data processing unit 11 stores data which is obtained by executing an application program and which becomes an object of exchange with another game apparatus (hereinafter, referred to as “exchangeable data”) in an exchangeable data storage area 71 (to be described later) of the auxiliary storage device 103. Exchangeable data includes user visible information that is set so as to be notified to a user and user invisible information that is set so as not to be notified to a user. Details of user visible information and user invisible information will be given later. In addition, when detection of a game apparatus to become a communication partner is notified from the communication processing unit 14 (the wireless communication module 107), the exchangeable data processing unit 11 executes a process for establishing a communication connection with a game apparatus of the communication partner. Subsequently, the exchangeable data processing unit 11 copies relevant exchangeable data stored in the exchangeable data storage area 71 and transmits the exchangeable data to the game apparatus of the communication partner. The exchangeable data is transmitted to the game apparatus of the communication partner via the wireless communication module 107. The exchangeable data processing unit 11 is an example of a “processing unit”. In addition, the exchangeable data is an example of “notification information”.

The received data processing unit 12 stores exchangeable data received via the wireless communication module 107 from the game apparatus of the communication partner detected by the communication processing unit 14 (hereinafter, referred to as “received data”) in a received data storage area 72 (to be described later) of the auxiliary storage device 103. The received data processing unit 12 is an example of a “receiving unit”.

In response to a request from an application program, the output processing unit 13 reads out received data of the application program stored in the received data storage area 72, and outputs the received data to the output device 105 (a display or the like). Accordingly, user invisible information included in the exchangeable data (received data) received from the game apparatus of the communication partner is outputted to the output device 105 of the game apparatus 1. As a result, the user of the game apparatus 1 is now able to access user invisible information of the communication partner. The output processing unit 13 is an example of a “display processing unit”.

The communication processing unit 14 executes a process for searching for another game apparatus (a communication partner searching process). For example, the communication partner searching process is as follows. For example, exchange judgment data including a judgment condition for judging a communication partner is stored in the auxiliary storage device of the wireless communication module 107. The exchange judgment data includes, for example, a MAC address that is identification information unique to the game apparatus 1, vendor identification information of the game apparatus 1, identification information of an application program (application identification information) registered to the game apparatus 1, and the like, whereby a part of or all of these information is used as a judgment condition of a communication partner. Moreover, an application program registered to the game apparatus 1 may be an application program having an execution history in the game apparatus 1, and is not limited to an application program stored in the auxiliary storage device 103 of the game apparatus 1 or in the portable recording medium 200 mounted to the game apparatus 1.

The communication processing unit 14 exchanges exchange judgment data with a game apparatus existing within the communication range of the game apparatus 1. When receiving exchange judgment data from another game apparatus 1, the communication processing unit 14 compares the exchange judgment data with its own exchange judgment data. As a result of the comparison between the exchange judgment data of the other game apparatus and its own exchange judgment data, when the exchange judgment data of the other game apparatus satisfies the judgment condition, the communication processing unit 14 notifies the other game apparatus to the exchangeable data processing unit 11 (the information processing unit 100 of the main body of the game apparatus 1) as a communication partner. Moreover, the communication processing unit 14 may exchange judgment data with all game apparatuses existing within the communication range of the game apparatus 1.

For example, in a case where the judgment condition is having consistent application identification information, the communication processing unit 14 judges whether or not application identification information included in the received exchange judgment data of the other game apparatus is consistent with application identification information included in its own exchange judgment data. If the application identification information is consistent, the communication processing unit 14 notifies the other game apparatus to, for example, the exchangeable data processing unit 11 as a communication partner. Moreover, when a plurality of units of application identification information is included in the exchange judgment data, the other game apparatus becomes a communication partner by having at least one consistent unit of application identification information.

Moreover, the judgment condition for a communication partner may include, for example, having consistent vendor identification information. In addition, the judgment condition for a communication partner may include corresponding to a MAC address registered in a MAC address list stored in the auxiliary storage device of the wireless communication module 107.

Moreover, for example, an exchange of exchange judgment data with another game apparatus is performed as described below. The communication processing unit 14 repetitively executes transmission of its own exchange judgment data and stands by for reception of exchange judgment data from another game apparatus at, for example, a predetermined period. When standing by for reception of exchange judgment data, the game apparatus 1 exchanges exchange judgment data by transmitting exchange judgment data to another game apparatus upon receiving exchange judgment data from the other game apparatus. During transmission of exchange judgment data, the game apparatus 1 exchanges exchange judgment data by receiving exchange judgment data from another game apparatus that has received exchange judgment data from the game apparatus 1.

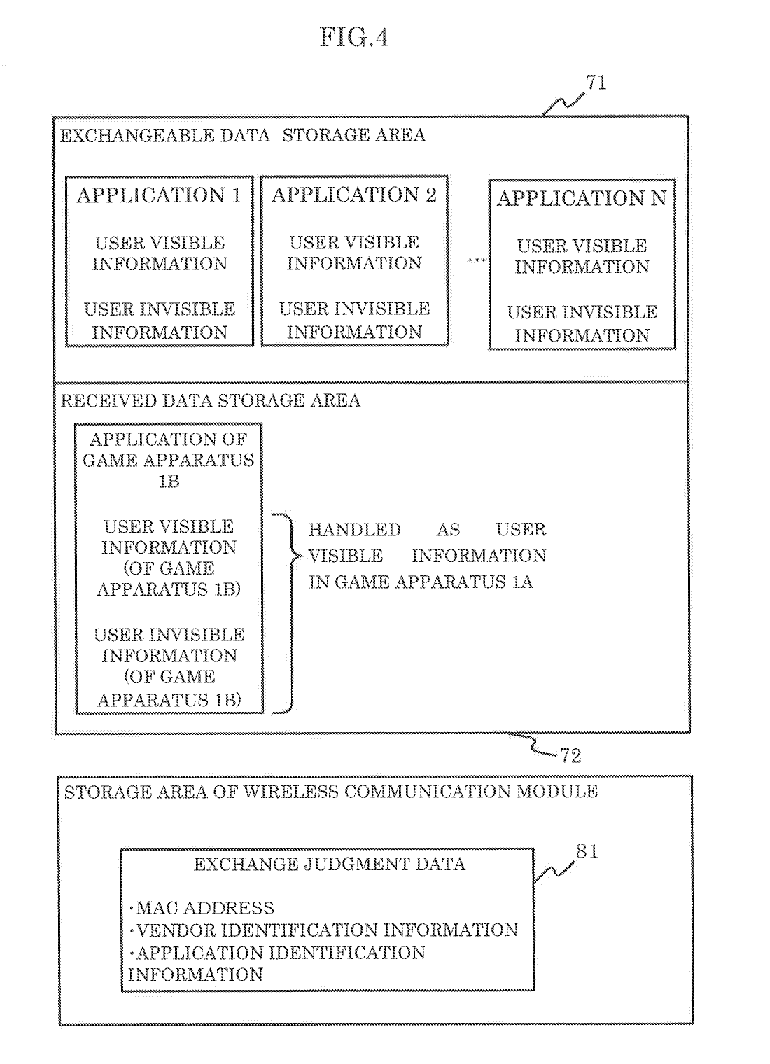

FIG. 4 is a diagram illustrating an example of usage of a storage area of the auxiliary storage device 103 of the game apparatus 1 and a storage area of the auxiliary storage device of the wireless communication module 107. The storage area of the auxiliary storage device 103 includes an exchangeable data storage area 71 and a received data storage area 72. However, areas included in the storage area of the auxiliary storage device 103 are not limited to the exchangeable data storage area 71 and the received data storage area 72. The auxiliary storage device 103 is an example of a “storage unit”. Moreover, FIG. 4 illustrates an example of usage of a storage area of the auxiliary storage device 103 of the game apparatus 1A that has performed data exchange with the game apparatus 1B through wireless communication, and a storage area of the auxiliary storage device of the wireless communication module 107.

Exchangeable data of each application program of the game apparatus 1 itself is stored in the exchangeable data storage area 71. Exchangeable data includes user visible information and user invisible information. User visible information is information set so as to be notified to a user by, for example, outputting the information to the output device 105 (a display or the like). In other words, user visible information is information that can be accessed by the user. User invisible information is information set so as not to be notified to a user. For example, information that does not impede progress of an application program even if not notified to a user, information that has little or no effect on progress, or information that has little or no relevance to progress is set as the user invisible information.

When the application program is a game program, the user visible information is, for example, a name of the game apparatus 1 given to the game apparatus 1, information that enables extrapolation of the user of the game apparatus 1 (a user name of the game apparatus 1, a character of the user), points owned, a name of a stage currently being played, or the like. In addition, in this case, the user invisible information is information that does not impede progress of the game even if a user is unaware of the information. For example, the user invisible information is the number of retries (the number of failures) of a state being played, the number of enemies defeated, a total play time, a special item that is not notified to the user of the game apparatus 1, or the like.

Exchangeable data (received data) received from the game apparatus of the communication partner is stored in the received data storage area 72. The received data includes user visible information and user invisible information of a user of the game apparatus of the communication partner. For example, when the application program is a game program, the user visible information of the received data includes, for example, a game apparatus name given to the game apparatus of the communication partner, a user name of the game apparatus of the communication partner, a character of the user of the communication partner, points owned by the communication partner, a name of a stage currently being played by the communication partner, or the like. In addition, for example, the user invisible information is the number of retries (the number of failures) of a state currently being played by the communication partner, a special item that is not notified to the user of the game apparatus of the communication partner, or the like. Data stored in the received data storage area 72 is handled by the game apparatus 1 as user visible information. In other words, user invisible information of the game apparatus 1B of the communication partner which is included in the received data is handled by the game apparatus 1A as user visible information. Therefore, user invisible information of the game apparatus of the communication partner which is included in received data is notified to the user of the game apparatus 1.

Exchange judgment data 81 is stored in the storage area of the auxiliary storage device of the wireless communication module 107. Details of exchange judgment data 81 are as described earlier.

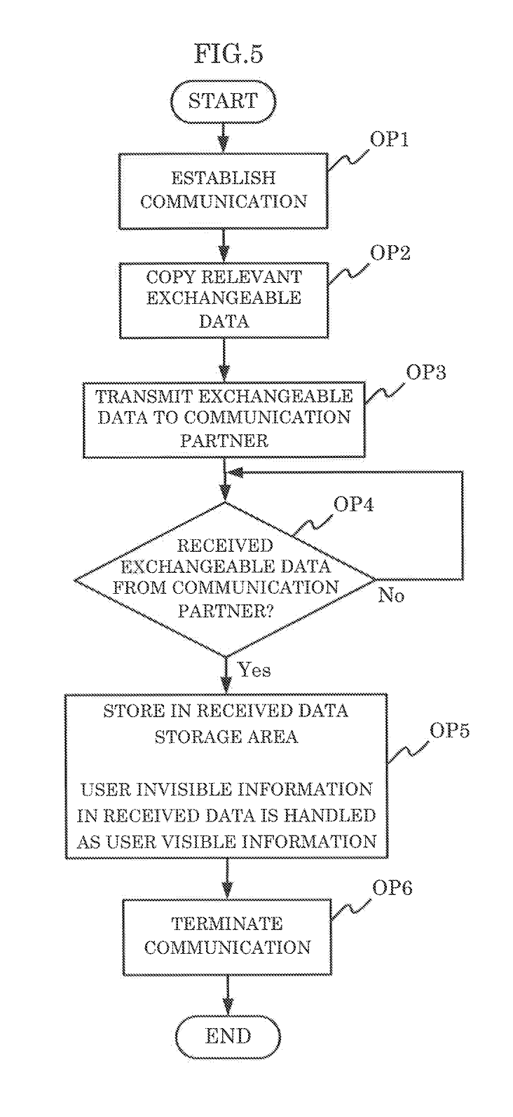

FIG. 5 illustrates an example of a flow chart of an exchangeable data transmission/reception process. The process illustrated in FIG. 5 is a part of processes implemented by executing the data exchange program 103p stored in the auxiliary storage device 103. The flow chart illustrated in FIG. 5 starts upon reception by the information processing unit 100 of a notification of detection of a communication partner from the wireless communication module 107.

In OP1, the information processing unit 100 executes a communication establishing process with a game apparatus of the communication partner detected by the wireless communication module 107. The process then proceeds to OP2.

In OP2, the information processing unit 100 copies relevant exchangeable data that is stored in the exchangeable data storage area 71. The copied exchangeable data is exchangeable data of an application program for which application identification information is found to be consistent between the game apparatus 1 and the game apparatus of the communication partner in a communication partner searching process performed by the wireless communication module 107. Exchangeable data includes user visible information and user invisible information. The process then proceeds to OP3.

In OP3, the information processing unit 100 transmits the copied exchangeable data to the game apparatus of the communication partner. The process then proceeds to OP4.

In OP4, the information processing unit 100 judges whether or not exchangeable data has been received from the game apparatus of the communication partner. When exchangeable data (received data) has been received from the game apparatus of the communication partner (OP4: Yes), the process proceeds to OP5. When exchangeable data has not been received from the game apparatus of the communication partner (OP4: No), the process of OP4 is repeated until the exchangeable data is received. Alternatively, when exchangeable data has not been received from the game apparatus of the communication partner (OP4: No), the information processing unit 100 may await reception of the exchangeable data for a predetermined period of time. When the exchangeable data has not been received even after the predetermined period of time has expired, the communication connection with the game apparatus of the communication partner may be terminated.

In OP5, the information processing unit 100 stores the received data in the received data storage area 72. The received data includes user invisible information of the game apparatus of the communication partner. By storing the received data in the received data storage area 72, the user invisible information of the game apparatus of the communication partner is handled as user visible information in the game apparatus 1. The process then proceeds to OP6.

In OP6, the information processing unit 100 terminates the communication connection with the game apparatus of the communication partner. Subsequently, the process illustrated in FIG. 5 is concluded.

The processes of OP1 to OP3 and OP6 correspond to a process of the exchangeable data processing unit 11. The processes of OP4 and OP5 correspond to a process of the received data processing unit 12.

Moreover, the flow chart illustrated in FIG. 5 is an example and, for example, exchangeable data can be transmitted to the game apparatus of the communication partner (the process of OP3) after confirming reception of the exchangeable data from the communication partner (the processes of OP5 and OP6).

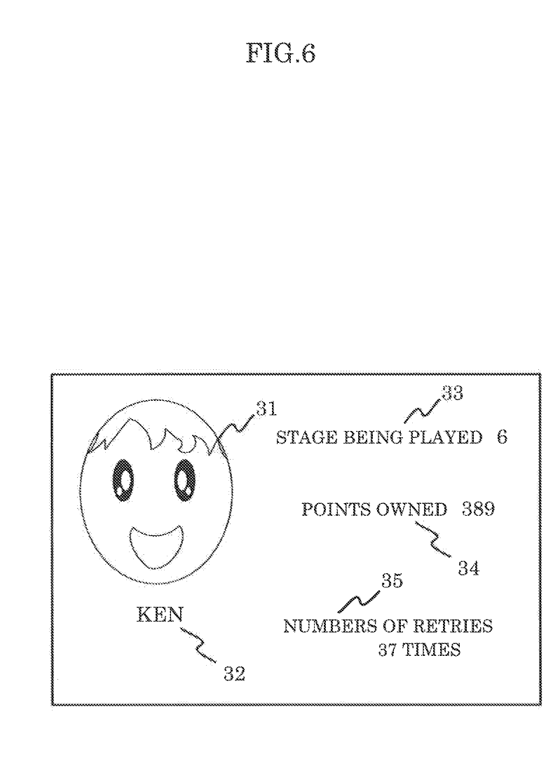

FIG. 6 illustrates an example of a display screen of exchangeable data (received data) received from the game apparatus of the communication partner. When a received data display event occurs due to execution of an application program, the received data is read out from the received data storage area 72 and displayed on a display. A received data display event is, for example, completing a predetermined game or input of an instruction to display the received data by a user.

The received data display screen illustrated in FIG. 6 displays, for example, as user visible information of the game apparatus of the communication partner, a character 31 of the user of the game apparatus of the communication partner, a user name 32 of the game apparatus of the communication partner, a stage 33 currently being played by the communication partner, and points 34 owned by the communication partner. In addition, as user invisible information of the game apparatus of the communication partner, the number of retries 35 by the communication partner is displayed. The number of retries 35 is information that is not notified by the game apparatus of the communication partner to the user of the game apparatus of the communication partner, and is therefore information that the user of the game apparatus of the communication partner is not aware of.

### Operational Advantage of Embodiment

According to the present embodiment, information that is not notified to the user of the game apparatus 1 is transmitted to and displayed by the game apparatus of the communication partner. As a result, since a user of the game apparatus of the communication partner gains information that the user of the game apparatus 1 is not aware of, a line of communication can be opened between both parties.

In addition, since the game apparatus 1 is a portable device, by moving about while carrying the game apparatus 1, the user is able to exchange data with users of a greater number of game apparatuses.

According to the present embodiment, communication between users of information processing apparatuses can be promoted.

(Other)

While the present embodiment has been described using the portable game apparatus 1, the data exchange program 103p according to the present disclosure may alternatively be executed on a stationary game apparatus or on a general information processing apparatus such as a personal computer.

In addition, while an example in which processes of the data exchange program 103p are performed by the game apparatus 1 has been used in the description above, at least a part of the process steps of the data exchange program 103p may be performed by another apparatus. For example, when the game apparatus 1 communicates with another apparatus (for example, a server), the process step of the game progress process described above may be executed by a collaboration of the game apparatus 1 and the other device. As one example, the other device may provide the auxiliary storage device 103 of the game apparatus 1 or, in other words, the exchangeable data storage area 71 and the received data storage area 72. As shown, the processes of the data exchange program 103p described above may be executed by a single processor or by a collaboration of a plurality of processors included in an information processing system comprising at least one information processing apparatus. Furthermore, while the processes according to the flow chart described above are performed by the execution of a predetermined program by the information processing unit 100 of the game apparatus 1 in the embodiment described above, a part of or all of the processes described above may be performed by a dedicated circuit provided in the game apparatus 1.

Moreover, in addition to the data exchange program 103p being provided to the game apparatus 1 through an external storage medium such as the portable recording medium 200, it may also be provided to the game apparatus 1 through a wired or wireless communication line. As the information storage medium for storing the data exchange program 103p, in addition to a nonvolatile memory, a CD-ROM, a DVD or other similar optical disk-shaped storage mediums, a flexible disk, a hard disk, a magneto optical disk, a magnetic tape and the like can also be used. Moreover, as the information storage medium for storing the data exchange program 103p, a volatile memory for temporarily storing the foregoing program may also be used. This kind of external storage medium is a recording medium that can be read by a computer or the like. For example, the various functions explained above can be provided by causing a computer or the like to read and execute the programs stored in the recording medium.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims. Moreover, it is understood that a person skilled in the art can implement an equivalent scope as the present disclosure based on the descriptions of the present disclosure and common technical knowledge from the description of the specific embodiment of the present disclosure. Moreover, the terms used in this specification are understood to have the meaning that is generally used in the relevant field unless a specific reference is made regarding such term. Accordingly, unless separately defined herein, all specialized terms and technical terms used in this specification shall have the same meaning as the terms which are generally understood by a person skilled in the art of the field to which the present disclosure belongs. If there is any inconsistency in the meaning of the terms, this specification (including the definitions) shall prevail.

What is claimed is:

1. A non-transitory computer readable recording medium recording an information processing program that is executed by an information processing apparatus capable of communication, the information processing program causing the information processing apparatus to function as:
a storage unit that stores invisible information set so as to be invisible to a user of the information processing apparatus; and
a transmitting unit that transmits notification information which includes the invisible information and which is to be notified to a user of another information processing apparatus, to the other information processing apparatus.

2. The non-transitory computer readable recording medium recording an information processing program according to claim 1, wherein the information processing program further causes the information processing apparatus to function as:
a receiving unit that receives notification information including invisible information set so as to be invisible to the user of the other information processing apparatus, from the other information processing apparatus; and
a display processing unit that causes the invisible information included in the notification information received by the receiving unit to be displayed on a display device.

3. The non-transitory computer readable recording medium recording an information processing program according to claim 1, wherein
the transmitting unit transmits visible information that is set so as to be visible to the user of the information processing apparatus by including the visible information in the notification information together with the invisible information that is set so as to be invisible to the user of the information processing apparatus.

4. The non-transitory computer readable recording medium recording an information processing program according to claim 3, wherein
the transmitting unit transmits, as the visible information, at least information that is enable to extrapolate of the user of the information processing apparatus.

5. The non-transitory computer readable recording medium recording an information processing program according to claim 4, wherein
the transmitting unit transmits, as information that is enable to extrapolate the user of the information processing apparatus, character data regarding the user of the information processing apparatus.

6. The non-transitory computer readable recording medium recording an information processing program according to claim 1, wherein
the transmitting unit transmits, to the other information processing apparatus that is capable of executing a common application program with the information processing apparatus, the invisible information which is related to the common application program and is set so as to be invisible to the user of the information processing apparatus, by including the invisible information in the notification information.

7. The non-transitory computer readable recording medium recording an information processing program according to claim 6, wherein
the common application program is a game program, and
the transmitting unit transmits, to the other information processing apparatus, the invisible information which does not impede progress of the game program and is set so as to be invisible to the user of the information processing apparatus, by including the invisible information in the notification information.

8. The non-transitory computer readable recording medium recording an information processing program according to claim 1, wherein
the information processing apparatus has a wireless communication function, and
the transmitting unit transmits the invisible information which is set so as to be invisible to the user of the information processing apparatus, to another information processing apparatus existing within a propagation range of radio waves transmitted by the information processing apparatus, by including the invisible information in the notification information.

9. The non-transitory computer readable recording medium recording an information processing program according to claim 8, wherein
the transmitting unit transmits the notification information to all other information processing apparatuses existing in the propagation range of radio waves transmitted by the information processing apparatus.

10. An information processing apparatus capable of communication, comprising:
a storage unit that stores invisible information set so as to be invisible to a user of the information processing apparatus; and
a transmitting unit that transmits notification information which includes the invisible information and which is to be notified to a user of another information processing apparatus, to the other information processing apparatus.

11. An information processing system comprising:
a storage unit that stores invisible information set so as to be invisible to a user of an information processing apparatus capable of communication; and
a transmitting unit that transmits notification information which includes the invisible information and which is to be notified to a user of another information processing apparatus, to the other information processing apparatus.

12. An information processing method executed by an information processing apparatus capable of communication comprising:
storing invisible information set so as to be invisible to a user of the information processing apparatus; and
transmitting notification information which includes the invisible information and which is to be notified to a user of another information processing apparatus, to the other information processing apparatus.
